(19) United States
(12) Patent Application Publication
(10) Pub. No.: US 2022/0186039 A1
(43) Pub. Date: Jun. 16, 2022

(54) CORROSION INHIBITOR FORMULATION

(71) Applicant: SHELL OIL COMPANY, HOUSTON, TX (US)

(72) Inventors: Richard POLLARD, Houston, TX (US); Neil PARK, Fort Saskatchewan (CA); Ali NARAGHI, Missouri City, TX (US)

(21) Appl. No.: 17/603,038

(22) PCT Filed: Apr. 30, 2020
(86) PCT No.: PCT/US2020/030662

§ 371 Date: Oct. 12, 2021

Related U.S. Application Data
(60) Provisional application No. 62/842,781, filed on May 3, 2019.

(51) Int. Cl. C09D 5/08; C09D 177/08; C09D 7/20; C09D 7/63; C09D 7/45; C08G 69/34

(52) U.S. Cl. CPC C09D 5/086; C09D 177/08; C08G 69/34; C09D 7/63; C09D 7/45; C09D 7/20

(57) ABSTRACT

A corrosion inhibitor has a film-forming portion. In one embodiment, the corrosion inhibitor further includes a surfactant, a coupling solvent and a carrier solvent. In another embodiment, the corrosion inhibitor has a film-forming portion that includes at least two multi-dentate compounds and a compound having a single active group. Each of the multi-dentate compounds and the compound having a single active group are selected from the group consisting of compounds having nitrogen-containing polar groups, compounds having acid groups and combinations thereof.

### FIELD OF THE INVENTION

The present invention relates to the field of corrosion inhibitors, and, in particular, to corrosion inhibitors for subsurface pipelines operating at high pressure and high temperature (HPHT) conditions.

### BACKGROUND OF THE INVENTION

In offshore hydrocarbon production operations, especially deepwater operations, corrosion is a key area of concern. Produced fluids include hydrocarbons, brine, CO2 and H2S. Oil production pipelines are typically formed from low carbon steel. At high temperature conditions, especially in the presence of CO2 and H2S, where pipelines are in contact with brine, laboratory tests suggest that the overall corrosion rate (OCR) can be as much as 2.5 cm/year (1-inch/yr), with an additional local thickness loss of about 2.5 cm/year (1-inch/yr) due to pitting. A pit is defined as being a surface imperfection greater than 10 microns deep.

In operation, corrosion is further exacerbated by the use of scale inhibitors that are also added to address flow assurance, particularly in deepwater operations. For HPHT conditions, scale inhibitors themselves tend to be corrosive.

A corrosion inhibitor (CI) is typically added to pipeline fluids to reduce the rate of corrosion. To maintain asset integrity over the lifetime of a field, a typical requirement is that the CI provides an OCR≤0.1 mm/yr (0.004 inches/yr) with no pitting. Preferably, this requirement is demonstrated in laboratory tests prior to field deployment. The avoidance of pitting is particularly important because, once started, it may not be possible to arrest pit growth.

Additional requirements for CIs for deep water are thermal stability and deliverability. A CI must have thermal stability at a wide variety of temperatures ranging from ambient temperatures on a floating platform to HPHT conditions, for example 120-180° C. (250-350° F.). A CI formulation must also be capable of being delivered from the floating platform to the subsea pipelines, typically through an umbilical having a diameter in the range of, for example, 0.5-5 cm (0.2-2 inches). In view of the relatively small diameter of the umbilical that travels through a range of temperature conditions from topsides to the sea floor, a CI formulation should have a low viscosity and should be resistant to forming plugs in the umbilical, for example, by gelling and/or forming solids.

A variety of CI compositions have been developed. For example, U.S. Pat. No. 5,322,640 (Byrne et al) describe a method for inhibiting corrosion by adding a water-soluble ampholytic substituted imidazoline. U.S. Pat. Nos. 6,696,572 and 6,448,411 (Meyer) describe methods for synthesizing quaternized imidazolines for use as a corrosion inhibitor, especially for sweet systems, where there is a relatively high CO2 concentration. U.S. Pat. Nos. 6,488,868 and 6,599,445 (Meyer) describes methods for synthesizing a quaternized substituted diethylamino compound for uses as a corrosion inhibitor. And US6,303,079 (Meyer) relates to synthesizing quaternized compounds, especially quaternized imidazolines, having an amido moiety.

These CI compositions, however, do not address the needs for deepwater operations. The present inventors have found that the use of a bis-imidazoline or a bis-quaternary ammonium compound as a single active component does not provide adequate corrosion protection under a simulated HPHT deepwater environment.

WO2018/111230A1 (Halliburton) relates to corrosion inhibition in acidic treatment fluids. The treatment fluid includes an aqueous base fluid, an acid, a corrosion inhibitor and a corrosion inhibitor intensifier. The aqueous base fluid acts as a solvent and includes aqueous fluids such as water and brine and aqueous-miscible fluids such as alcohols, glycerins, glycols, polyglycol amines and polyols. The acid is provided to acidize a formation and/or a fracture face. A variety of corrosion inhibitors are listed including coffee, tobacco, a polysaccharide, a tannin, an unsaturated alcohol, a quaternary ammonium compound and a bis-quaternary compound. The corrosion intensifier is selected from tetrahydrofurfuryl alcohol and/or tetrahydrofurfuryl amine

While designed for deepwater treatment in general, the composition appears to address the specific acidizing and fracture treatment of deepwater wells. The composition does not appear to provide the needs for inhibiting corrosion of a production pipeline.

There is a need for a corrosion inhibitor formulation that reduces pitting in oil production pipelines, especially for operating at deepwater HPHT conditions.

### SUMMARY OF THE INVENTION

According to one aspect of the present invention, there is provided a corrosion inhibitor composition, comprising: a film-forming portion, a surfactant, a coupling solvent and a carrier solvent.

According to another aspect of the present invention, there is provided a corrosion inhibitor composition having a film-forming portion, wherein the film-forming portion is comprised of at least two multi-dentate compounds and a compound having a single active group, wherein each of the multi-dentate compounds and the compound having a single active group are selected from the group consisting of compounds having nitrogen-containing polar groups, compounds having acid groups and combinations thereof.

### DETAILED DESCRIPTION OF THE INVENTION

The corrosion inhibitor (CI) formulation of the present invention provides protection against corrosion (overall and localized) for low carbon steel oil-production pipelines operating at deepwater conditions, including high pressure, high temperature (HPHT) and sour conditions. As used herein, HPHT conditions refer to a temperature in a range of, for example, 120-180° C. (approximately 250-350° F.) and a pressure that is typically greater than 83 MPa (>12,000 psi). The CI formulation of the present invention is particularly effective for mildly sour conditions of many deepwater operations where there is a relatively high level of CO2, for example a partial pressure in the range of 240-310 kPa (35-45 psi) and some H2S, typically 0.2-1.5 kPa (approximately 0.03-0.2 psi).

In accordance with the present invention, the components in the CI formulation are thermally stable and the CI improves corrosion protection performance of deepwater pipelines. The CI formulation is effective in the presence of corrosive scale inhibitors (SI) often used in deepwater operations.

The CI formulation of the present invention includes a film-forming portion. In one embodiment, the CI formulation includes a film-forming portion, a surfactant, a coupling solvent and a carrier solvent. In another embodiment, the CI formulation has film-forming portion that has at least two multi-dentate compounds and a compound having a single active group. The embodiments of the CI formulation of the present invention take into consideration three main factors.

First, desorption is a dynamic, activated process that becomes more rapid at higher temperatures. A multi-dentate compound, i.e., a compound with at least two atoms that can bond independently to the surface, improves chemisorption to a metal surface. In accordance with the present invention, the multi-dentate compound should have similar bond strength for all the adsorbing atoms (otherwise one atom may adsorb but not the other). The multi-dentate compound should also balance the spatial distance L between the adsorbed atoms. If L is too short, there is likely to be bond strain and a concomitant diminution of bond strength. If L is too large, there may be “gaps” in protection between the sites at which the molecule is adsorbed.

Second, rates of thermal and chemical decomposition of CI components increase with temperature. Specifically, there is a risk that adsorbates will degrade and lose their protective capability. Typically, the CI formulation is added continuously to the pipeline. The components of the CI formulation of the present invention are selected to have a degradation rate less than the rate of replenishment in the field.

Third, corrosion is an electrochemical reaction that can occur when metal contacts brine but not when it contacts oil. Therefore, an objective with a film-forming portion is to cover the metal surface to hinder contact with ions from the brine. Adsorption of large active compound molecules will provide steric hindrance for filling metal sites nearby, e.g., between two large adsorbates. The inventors have discovered that the film-forming portion should include one or more smaller active compounds that will adsorb at the interstitial surface sites between larger active compounds. Furthermore, film-forming compounds that preferentially reside in the oil are selected to be dispersible in brine so that they can be delivered to metal surfaces that are wet by brine for extended periods. Some conventional CI approaches have been to use water-soluble compounds for inhibiting corrosion, as discussed herein. However, protective layers with such compounds might not be hydrophobic and are prone to low persistency because of limited thermal stability and a tendency for rapid desorption. Therefore, conventional water-soluble film-forming compounds may have difficulty protecting, especially at high wall shear stresses or at welds. Moreover, water-dispersible CIs may stick to sand particles or asphaltenes in the produced fluids or have greater affinity for oil/water interfaces.

Accordingly, the present inventors have discovered that a CI formulation should (a) provide active compounds with a range of solubilities in the brine, (b) include surfactants that enhance dispersibility of oil-soluble active compounds, and (c) provide active compounds that also contain non-adsorbing functional groups that interact with functional groups in the surfactant(s) or coupling solvent to enhance dispersibility.

The present inventors have also discovered that a CI formulation is more effective with a film-forming portion that has at least two multi-dentate compounds and a compound having a single active group.

As noted above, the CI formulation of the present invention includes a film-forming portion. The film-forming portion is adsorbed on the surface of the metal or possibly to surface deposits attached to the metal to reduce the rates of electrochemical corrosion reactions. In one embodiment, the film-forming portion includes at least two multi-dentate compounds and at least one compound that has a single active group for adsorbing to the metal surface. Preferably, the film-forming portion includes at least two compounds having nitrogen-containing polar groups compounds and/or acid groups.

The multi-dentate film-forming compounds act to adsorb at two or more locations, thereby improving bond strength and coverage. However, an adsorbed multi-dentate compound introduces steric hindrance for the bonding of another adsorbed multi-dentate compound. Accordingly, interstitial spaces may exist where the metal surface is not adequately protected against corrosion. For example, the present inventors have discovered that the use of a bis-imidazoline or a bis-quaternary ammonium compound alone did not provide adequate corrosion protection.

Preferably, the film-forming portion further includes a compound with a single active group. Without being bound by theory, it is believed that the compound with a single active group improves the corrosion protection to protect the interstitial spaces between multi-dentate compounds.

Examples of compounds having a single active group include, without limitation, alkylated pyridines, amides, alkylated amines, alkoxylated amines, and combinations thereof. Preferably, the compound having a single active group is an alkylated pyridine. Preferably, the alkylated pyridine is present in an amount in the range of from 5 to 10 wt % of the corrosion inhibitor composition.

Examples of multi-dentate compounds include, without limitation, imidazolines, quaternary ammonium compounds, functionalized fatty acids, and combinations thereof. Suitable functionalized fatty acids include, without limitation, maleated tall oil fatty acids, dimer fatty acids, trimer fatty acids, amine fatty acids, and combinations thereof. Suitable imidazolines include, without limitation, bis-imidazolines, such as a bis-imidazoline produced from a tall oil fatty acid (TOFA) and tetraethylenepentamine (TEPA). Preferably, the film-forming portion includes two or more of a bis-imidazoline, a bis-quaternary ammonium compound and a maleated tall oil fatty acid. More preferably, the film-forming portion is a combination of bis-imidazoline, a bis-quaternary ammonium compound, a maleated tall oil fatty acid, and an alkylated pyridine.

In a preferred embodiment, the bis-imidazoline and the bis-quaternary ammonium compound are present in a weight ratio in the range of from 0.7:1 to 1.5:1. Preferably, the total amount of the bis-imidazoline and the bis-quaternary ammonium compound is in the range of from 20 to 40 wt % of the corrosion inhibitor composition. Preferably, the maleated tall oil fatty acid is present in an amount in the range of from 3 to 10 wt % of the CI composition.

In one embodiment, the CI composition of the present invention further includes a pit-arresting compound. The pit-arresting compound also has a film-forming functionality and is adsorbed by exposed surfaces of surface defects and pits to help prevent further corrosion. Examples of suitable pit-arresting compounds include, without limitation, phosphated alcohols, phosphated esters, alkoxylated alcohols, alkoxylated esters, and combinations thereof. Preferably, the pit-arresting compound is a phosphated ester present in an amount in the range of from 5 to 10 wt % of the CI composition.

The surfactant is provided to the CI of the present invention to assist in dispersing the film-forming portions into brine. In particular, the surfactant should be selected for thermal stability. Examples of suitable surfactants include, without limitation, ethoxylated tallow alkyl amine, alkoxylated nonyl phenol, alkoxylated fatty acids, diethanolamine, xylene sulfonic acid, and combinations thereof. Preferably, the surfactant is selected from the group consisting of alkoxylated nonyl phenol, alkoxylated fatty acids, diethanolamine, and combinations thereof. More preferably, the surfactant is an ethoxylated fatty acid present in an amount in the range of from 3 to 10 wt % of the CI composition.

The coupling solvent component of the CI composition of the present invention increases dispersibility of active components, such as those in the film-forming portion, in the brine. Examples of suitable coupling solvents include, without limitation, ethylene glycol mono-butyl ether, methyl carbitol, and combinations thereof. Preferably, the coupling solvent is methyl carbitol present in an amount in the range of from 30 to 40 wt % of the CI composition.

The carrier solvent is provided in the CI composition of the present invention to reduce phase separation. As well, the carrier solvent lowers the viscosity of the composition to help facilitate delivery of the CI via an umbilical. The present inventors have determined that the use of water as part of the carrier solvent had an adverse effect on the performance of the CI, possibly because the water hydrolyzes the components of the CI composition. Methanol may be an unsuitable choice as a carrier solvent because it could vaporize if the umbilical is de-pressurized. Examples of suitable carrier solvents include, without limitation, isopropyl alcohol, light aromatic naphtha, xylene, and combinations thereof. Preferably, the carrier solvent is selected from isopropyl alcohol, xylene, and combinations thereof. More preferably, the carrier solvent is isopropyl alcohol present in an amount in the range of from 10 to 25 wt % of the CI composition.

The CI composition of the present invention may also include or be used with other components such as scale inhibitors, demulsifiers, defoamers, facilitators and activators, as will be understood by those skilled in the art.

In operation, the CI formulation is added to the pipeline in a continuous manner The amount of CI formulation added will be dependent on the specific operating conditions, as well as other additives, such as scale and hydrate inhibitors, that may be used. An example of a suitable amount of CI formulation for HPHT conditions is 50-150 ppm or as much as, for example, 600 ppm. The CI formulation will preferably have a viscosity less than 50 mPa·s (50 cP) to reduce the risk of plugging the umbilical. For this reason, it may be desirable to dilute the CI formulation. A preferred diluent is one or more solvents, which may be the same or different than the solvents used in the original CI composition. After dilution, the total amount of solvent is expected to be in the range, for example, of 48 to 60 wt %.

The following non-limiting examples of preferred embodiments of CI compositions as claimed herein are provided for illustrative purposes only.

### EXAMPLES

### Example 1

One embodiment of the CI composition of the present invention was tested for its corrosion inhibiting performance The composition is provided in Table 1.

TABLE 1

| | | Concentration |
|---|---|---|
| Component | Compound | (wt. %) |
| Film-forming portion | bis-imidazoline | 10-20 |
| | bis-quaternary ammonium | 10-20 |
| | compound | |
| | maleated tall oil fatty acid | 3-10 |
| | alkylated pyridine | 5-10 |
| Pit-Arresting compound | phosphate ester | 5-10 |
| Surfactant | ethoxylated fatty acid | 3-10 |
| Coupling solvent | methyl carbitol | 30-40 |
| Carrier Solvent | isopropyl alcohol | 10-25 |

The tests were conducted in a 325-mL autoclave equipped with thermal insulation to minimize local condensation of water vapor. The testing medium was a mixture of brine (64 mL) and oil (136 mL). The brine was a synthetic brine having a composition as shown in Table 1 was prepared and added to the autoclave. The sulfate and bicarbonate were added directly to the autoclave to avoid precipitation. A formula is needed for adding the correct amount of MgCl2 because it is hygroscopic.

TABLE 2

| | Concentration |
|---|---|
| Salt | (g/L) |
| CaCl₂•2H₂O | 100.7 |
| MgCl₂ | 1.8 (w/w_{D}) |
| NaCl | 139.3 |
| NaC₂H₃O₂•3H₂O | 0.2 |
| BaCl₂•2H₂O | 0.02 |
| SrCl₂•6H₂O | 3.6 |
| NaBr | 1.2 |
| KCl | 8.4 |
| NaHCO₃ | 0.2 |
| Na₂SO₄ | 0.3 |

where w is initial weight and w_{D} is weight immediately after drying.

600 ppm (based on the brine) of CI was then added to the autoclave. Then, oil was added as a mixture of 90% LVT200, a hydrotreated light distillate, and 10% Aromatic 150, a heavy aromatic naphtha.

A working electrode was provided as a test low alloy steel coupon (API 5L X-65) with a surface area of 49 mm was placed in the autoclave. Reference (436 mm² Pt) and counter-electrodes (436 mm² HASTELLOY™ C276) were lowered into the solution.

The system was heated to 121° C. (250° F.), while stirring at 400 rpm, for 6 days. A test was also conducted at 149° C. (300° F.) and 177° C. (350° F.). In each case, 0.3-0.7 kPag (0.05-0.1 psig) H₂S and 207-276 kPa (30-40 psig) CO₂ were added to simulate conditions in a HPHT operation. To further test the CI under operating conditions, a proprietary scale inhibitor (SI) was added in an amount of 50 ppm (based on the brine). The SI is itself corrosive but must be added for flow assurance purposes. Therefore, it is necessary for the CI to perform well even in the presence of the SI.

Where observed, pit depths were determined using a Zeiss SMC2009 AXIOVERT™ phase-contrast microscope with axial-stage controller. The results are presented in Table 3.

### Example 2

Another embodiment of the CI composition of the present invention was tested in the same manner as Example 1. The CI composition was the same as in Example 1 but diluted by adding 33% of mixed solvent.

The CI compositions were tested in the same manner as described in Example 1.

The results are presented in Table 3. The improved results illustrate the beneficial effects of solvents that can help increase the dispersibility of the active compounds. The diluted CI formulation met the performance requirements except for one pit for 6 coupons, and that one with a depth only just above the designated minimum for a pit.

TABLE 3

| | Example 1 (6-day tests) | | | | | |
|---|---|---|---|---|---|---|
| | OCR | | | Example 2 (6-day tests) | | |
| CI | mm/yr | | Pit Depth | OCR | | Pit Depth |
| T(° C.) | (mils/yr) | # Pits | (μm) | (mils/yr) | # Pits | (μm) |
| 177 | 0.17 | 0 | NA | 0.09 | 0 | NA |
| | (6.6) | | | (3.6) | | |
| | 0.08 | 1 | 13 | 0.06 | 0 | NA |
| | (3.0) | | | (2.4) | | |
| 149 | 0.09 | 1 | 13 | 0.09 | 1 | 12 |
| | (3.6) | | | (3.6) | | |
| | 0.09 | 1 | 11 | 0.05 | 0 | NA |
| | (3.6) | | | (1.8) | | |
| 121 | 0.08 | 2 | 11-12 | 0.03 | 0 | NA |
| | (3.0) | | | (1.2) | | |
| | 0.12 | 0 | NA | 0.03 | 0 | NA |
| | (4.8) | | | (1.2) | | |

While preferred embodiments of the present invention have been described, it should be understood that various changes, adaptations and modifications can be made therein within the scope of the invention(s) as claimed below.

1. A corrosion inhibitor composition, comprising: a film-forming portion, a surfactant, a coupling solvent and a carrier solvent.

2. The corrosion inhibitor composition of claim 1, wherein the film-forming portion is selected from the group consisting of compounds having nitrogen-containing polar groups, compounds having acid groups and combinations thereof.

3. The corrosion inhibitor composition of claim 1, wherein the film-forming portion is comprised of at least two multi-dentate compounds and a compound having a single active group.

4. The corrosion inhibitor composition of claim 3, wherein the compound having a single active group is selected from the group consisting of alkylated pyridines, amides, alkylated amines, alkoxylated amines, and combinations thereof.

5. The corrosion inhibitor composition of claim 4, wherein the compound having a single active group is an alkylated pyridine.

6. The corrosion inhibitor composition of claim 5, wherein the alkylated pyridine is present in an amount in the range of from 5 to 10 wt % of the corrosion inhibitor composition.

7. The corrosion inhibitor composition of claim 3, wherein each of the multi-dentate compounds is selected from the group consisting of imidazolines, quaternary ammonium compounds, functionalized fatty acids, and combinations thereof.

8. The corrosion inhibitor composition of claim 7, wherein the functionalized fatty acid is selected from the group consisting of maleated tall oil fatty acids, dimer fatty acids, trimer fatty acids, amine fatty acids and combinations thereof.

9. The corrosion inhibitor composition of claim 7, wherein one of the multi-dentate compounds is a bis-imidazoline produced from a tall oil fatty acid and tetraethylenepentamine

10. The corrosion inhibitor composition of claim 7, wherein the multi-dentate compounds comprise a bis-imidazoline and a bis-quaternary ammonium compound.

11. The corrosion inhibitor composition of claim 10, wherein the bis-imidazoline and the bis-quaternary ammonium compound are present in a weight ratio in the range of from 0.7:1 to 1.5:1.

12. The corrosion inhibitor composition of claim 10, wherein the total amount of the bis-imidazoline and the bis-quaternary ammonium compound is in the range of from 20 to 40 wt % of the corrosion inhibitor composition.

13. The corrosion inhibitor composition of claim 1, wherein the film-forming portion is a combination of a bis-imidazole, a bis-quaternary ammonium compound, a maleated tall oil fatty acid and an alkylated pyridine.

14. The corrosion inhibitor composition of claim 13, wherein the maleated tall oil fatty acid is present in an amount in the range of from 3 to 10 wt % of the corrosion inhibitor composition.

15. The corrosion inhibitor composition of claim 1, wherein the surfactant is selected from the group consisting of ethoxylated tallow alkyl amine, alkoxylated nonyl phenol, alkoxylated fatty acids, diethanolamine, xylene sulfonic acid, and combinations thereof.

16. The corrosion inhibitor composition of claim 15, wherein the surfactant is an ethoxylated fatty acid present in an amount in the range of from 3 to 10 wt % of the corrosion inhibitor composition.

17. The corrosion inhibitor composition of claim 1, wherein the coupling solvent is selected from the group consisting of ethylene glycol mono-butyl ether, methyl carbitol, and combinations thereof.

18. The corrosion inhibitor composition of claim 17, wherein the coupling solvent is methyl carbitol present in an amount in the range of from 30 to 40 wt % of the corrosion inhibitor composition.

19. The corrosion inhibitor composition of claim 1, wherein the carrier solvent is selected from the group consisting of isopropyl alcohol, light aromatic naphtha, xylene, and combinations thereof.

20. The corrosion inhibitor composition of claim 19, wherein the carrier solvent is isopropyl alcohol present in an amount in the range of from 10 to 25 wt % of the corrosion inhibitor composition.

21. The corrosion inhibitor composition of claim 1, further comprising a pit-arresting compound selected from the group consisting of phosphated alcohols, phosphated esters, alkoxylated alcohols, alkoxylated esters, and combinations thereof.

22. The corrosion inhibitor composition of claim 21, wherein the pit-arresting compound is a phosphated ester present in an amount in the range of from 5 to 10 wt % of the corrosion inhibitor composition.

23. A corrosion inhibitor composition having a film-forming portion, wherein the film-forming portion is comprised of at least two multi-dentate compounds and a compound having a single active group, wherein each of the multi-dentate compounds and the compound having a single active group are selected from the group consisting of compounds having nitrogen-containing polar groups, compounds having acid groups and combinations thereof.

24. The corrosion inhibitor composition of claim 23, wherein the compound having a single active group is selected from the group consisting of alkylated pyridines, amides, alkylated amines, alkoxylated amines, and combinations thereof.

25. The corrosion inhibitor composition of claim 24, wherein the compound having a single active group is an alkylated pyridine.

26. The corrosion inhibitor composition of claim 25, wherein the alkylated pyridine is present in an amount in the range of from 5 to 10 wt % of the corrosion inhibitor composition.

27. The corrosion inhibitor composition of claim 23, wherein each of the multi-dentate compounds is selected from the group consisting of imidazolines, quaternary ammonium compounds, functionalized fatty acids, and combinations thereof.

28. The corrosion inhibitor composition of claim 27, wherein the functionalized fatty acid is selected from the group consisting of maleated tall oil fatty acids, dimer fatty acids, trimer fatty acids, amine fatty acids and combinations thereof.

29. The corrosion inhibitor composition of claim 27, wherein one of the multi-dentate compounds is a bis-imidazoline produced from a tall oil fatty acid and tetraethylenepentamine

30. The corrosion inhibitor composition of claim 27, wherein the multi-dentate compounds comprise a bis-imidazoline and a bis-quaternary ammonium compound.

31. The corrosion inhibitor composition of claim 30, wherein the bis-imidazoline and the bis-quaternary ammonium compound are present in a weight ratio in the range of from 0.7:1 to 1.5:1.

32. The corrosion inhibitor composition of claim 31, wherein the total amount of bis-imidazoline and the bis-quaternary ammonium compound is in the range of from 20 to 40 wt % of the corrosion inhibitor composition.

33. The corrosion inhibitor composition of claim 23, wherein the film-forming portion is a combination of a bis-imidazole, a bis-quaternary ammonium compound, a maleated tall oil fatty acid and an alkylated pyridine.

34. The corrosion inhibitor composition of claim 33, wherein the maleated tall oil fatty acid is present in an amount in the range of from 3 to 10 wt % of the corrosion inhibitor composition.

35. The corrosion inhibitor composition of claim 23, further comprising a pit-arresting compound.

36. The corrosion inhibitor composition of claim 35, wherein the pit-arresting compound is selected from the group consisting of phosphated alcohols, phosphated esters, alkoxylated alcohols, alkoxylated esters, and combinations thereof.

37. The corrosion inhibitor composition of claim 36, wherein the pit-arresting compound is a phosphated ester present in an amount in the range of from 5 to 10 wt % of the corrosion inhibitor composition.

38. The corrosion inhibitor composition of claim 23, further comprising a surfactant.

39. The corrosion inhibitor composition of claim 38, wherein the surfactant is selected from the group consisting of ethoxylated tallow alkyl amine, alkoxylated nonyl phenol, alkoxylated fatty acids, diethanolamine, xylene sulfonic acid, and combinations thereof.

40. The corrosion inhibitor composition of claim 39, wherein the surfactant is an ethoxylated fatty acid present in an amount in the range of from 3 to 10 wt % of the corrosion inhibitor composition.

41. The corrosion inhibitor composition of claim 23, further comprising a coupling solvent.

42. The corrosion inhibitor composition of claim 41, wherein the coupling solvent is selected from the group consisting of ethylene glycol mono-butyl ether, methyl carbitol, and combinations thereof.

43. The corrosion inhibitor composition of claim 42, wherein the coupling solvent is methyl carbitol present in an amount in the range of from 30 to 40 wt % of the corrosion inhibitor composition.

44. The corrosion inhibitor composition of claim 23, further comprising a carrier solvent.

45. The corrosion inhibitor composition of claim 44, wherein the carrier solvent is selected from the group consisting of isopropyl alcohol, light aromatic naphtha, xylene, and combinations thereof.

46. The corrosion inhibitor composition of claim 45, wherein the carrier solvent is isopropyl alcohol present in an amount in the range of from 10 to 25 wt % of the corrosion inhibitor composition.
